(19) United States
(12) Patent Application Publication
(10) Pub. No.: US 2005/0014536 A1
(43) Pub. Date: Jan. 20, 2005

(54) Modular adaptor assembly for personal digital appliance

(76) Inventor: Jeff Grady, Durham, NC (US)

Correspondence Address: INTELLECTUAL PROPERTY / TECHNOLOGY LAW, PO BOX 14329, RESEARCH TRIANGLE PARK, NC, 27709, US

(21) Appl. No.: 10/621,500

(22) Filed: Jul. 17, 2003

(51) Int. Cl. H04M 1/00; H04B 1/38

(52) U.S. Cl. 455/573

(57) ABSTRACT

An adaptor for a personal digital appliance. The adaptor includes an FM transmitter and power supply/charging assembly electrically coupleable with the personal digital appliance. The adaptor comprises a modular docking unit having a main body portion with a docking cavity therein, wherein the main body portion contains the FM transmitter and power/charging circuitry, with coupling means in the docking cavity for connecting the personal digital appliance with the FM transmitter and power/charging circuitry, to accommodate FM transmission by the FM transmitter of audio content when produced by the personal digital appliance in the docking cavity of the modular docking unit. The adaptor includes means for transmitting electrical power through the modular docking unit and the power/charging circuitry therein, for charging of a battery of the personal digital appliance and/or powering of the personal digital appliance.

### CROSS-REFERENCE TO RELATED APPLICATIONS

This is a continuation-in-part of U.S. patent application Ser. No. 10/______ filed Jul. 8, 2003 in the name of Jeff Grady for “FM TRANSMITTER AND POWER SUPPLY/CHARGING ASSEMBLY FOR MP3 PLAYER,” which in turn is a continuation-in-part of U.S. patent application Ser. No. 10/197,367 filed Jul. 17, 2002 in the name of Jeff Grady for “FM TRANSMITTER AND POWER SUPPLY/CHARGING ASSEMBLY FOR MP3 PLAYER,” issuing Jul. 8, 2003 as U.S. Pat. No. 6,591,085.

### BACKGROUND OF THE INVENTION

1. Field of the Invention

This invention relates to accessories for personal digital appliances, including personal digital assistants (PDAs), wireless telecommunications devices (e.g., cellular telephones), and MP3 players used for on-line downloading, storage and playing of music. More specifically, the invention relates to an adaptor that includes a digital FM transmitter, a power supply/charging assembly and optionally microphone/speaker components, in which the adaptor is matably engageable with the personal digital appliance as a docking base therefor. The invention also relates to a kit comprising such adaptor in combination with other mounting/power/charging accessories.

In a specific embodiment, the invention relates to accessories for MP3 players used for on-line downloading, storage and playing of music. More specifically, the invention in such specific embodiment relates to an FM transmitter and power supply/charging assembly for such MP3 players, and to a kit comprising such assembly in combination with other mounting/power/charging accessories.

2. Description of the Related Art

Music players of widely varying type are ubiquitous throughout the world, and have evolved through various forms over the years, from portable single transistor radios in the 1950's to tape cassette players to compact disc players and more recently to MP3 players, which enable a user to download audio material from an internet site and store same in storage medium of a player in an MP3 (MPEG-1 audio layer 3) format for subsequent selective listening.

A number of MP3 players have been developed and are commercially available, including the Nomad jukebox commercially available from Creative Labs, SonicBlue's rio volt, jukebox recorder commercially available from Archos Technology, and numerous others. A high-capacity MP3 player of such type is the iPOD™ MP3 player commercially introduced by Apple Computer, Inc. (Cupertino, Calif.) in 2001. The Apple iPOD has a capacity for approximately 1000 songs of commercial play length.

MP3 players of the aforementioned type rely on batteries for their portability, and are typically provided with a headset for user listening.

One problem associated with the small size and light-weight characteristics of such MP3 players, as requisite to their portability and ease of use, is battery life. Another problem is the personal character of the headphone-equipped MP3 player. The MP3 player may be equipped with a speaker, but its small size and light-weight characteristics limit the size of the speaker, making it less than desirable when it is desirable to transmit music to a group of persons, such as in a vehicle passenger compartment, or a room.

The aforementioned problems associated with MP3 players are also shared with other personal digital appliances. Examples include wireless telecommunication devices such as cellular and satellite telephones, hand-held computers with wireless networking capability and/or voice interface software, and a variety of convergent devices, which are in development and entering the market.

An illustrative convergent device that is currently being commercialized is the Treo 600 integrated voice/data device available from Palm, Inc. This device incorporates personal digital assistant functionality with a keyboard for data entry, an expansion slot for MP3 and wireless networking connections, and a built-in camera, together with telephony functionality in CDMA or GSM/GPRS formats.

Convergent devices of such type are proliferating in the market. Size and functionality restrictions will increasingly reduce manual input features in favor of voice interfaces, and the resulting convergent devices will become progressively more ubiquitous as essential portable accessories.

Currently, wireless telephony devices, whether integrated in convergent devices or used as dedicated single-function units, are pervasive in use. Such devices, while affording a high degree of flexibility in use, nonetheless entail associated risks when same are employed in vehicles where their hand-held character restricts ability of drivers to utilize both hands in a free manner for the operation of the vehicle. This is a deficiency and danger that is increasingly being addressed by laws banning or restricting the use of cell phones by a driver in a moving vehicle.

Another deficiency of all of the aforementioned personal digital appliances is the limited character of the power supplies employed in such appliances. Batteries employed in such appliances are typically of the rechargeable type, and require recharging in connection to a power source.

The art continues to seek improvements to address the above-discussed deficiencies of personal digital appliances.

### SUMMARY OF THE INVENTION

This invention relates to accessories for personal digital appliances, including personal digital assistants (PDAs), wireless telecommunications devices (e.g., cellular telephones), and MP3 players used for on-line downloading, storage and playing of music. More specifically, the invention relates to an adaptor that includes a digital FM transmitter, a power supply/charging assembly and optionally microphone/speaker components, in which the adaptor is matably engageable with the personal digital appliance as a docking base therefor.

The invention also relates to a kit comprising such adaptor in combination with other mounting/power/charging accessories.

In one aspect, the invention relates to an adaptor for a personal digital appliance, such adaptor including an FM transmitter and power supply/charging assembly electrically coupleable with the personal digital appliance, the adaptor comprising a modular docking unit having a main body portion with a docking cavity therein, wherein the main body portion contains the FM transmitter and power/charging circuitry, with coupling means in the docking cavity for connecting the personal digital appliance with the FM transmitter and power/charging circuitry, to accommodate FM transmission by the FM transmitter of audio content when produced by the personal digital appliance in the docking cavity of the modular docking unit, and with means for transmitting electrical power through the modular docking unit and the power/charging circuitry therein, for charging of a battery of the personal digital appliance and/or powering of the personal digital appliance.

The invention relates in another aspect to an FM transmitter and power supply/charging assembly for an MP3 player.

In one embodiment, the FM transmitter and power supply/charging assembly comprises a unitary and modular docking unit, in which the MP3 player is reposable in electrical communication therewith. The docking unit in a specific embodiment accommodating the iPOD™ MP3 player, the docking unit interconnects with the MP3 player via the MP3 player headphone and firewire ports. In other embodiments, accommodating MP3 players without firewire ports, the docking unit may interconnect with the MP3 player via the headphone and power port. The base docking unit contains within the unitary housing an FM transmitter and firewire power plug for the MP3 player. The base docking unit is provided with a matable plug coupling, for joining of the base docking unit to any of suitable power/charging components attachable thereto.

In another embodiment, the base docking unit of the FM transmitter and power supply/charging assembly is provided as a component of a multi-accessory kit. The kit comprises, in addition to the base docking unit, a ratcheting arm coupleable with a cigarette lighter power socket, e.g., a conventional 12 volt socket, in which the arm also functions as a mounting device which is pivotably adjustable to spatially position the MP3 player and affixed docking unit in any of a variety of spatial positions, relative to the user. The kit optionally also includes a short adaptor coupleable with a power supply, e.g., in a desk mount or wall mount plate. The kit optionally further includes a desk mount that is engagable with the short adaptor, to provide a desk mountable conformation of the MP3 player, and/or a wall mount plate for wall mounting of the FM transmitter and power supply/charging assembly, so that the MP3 player may be disposed in the modular docking unit as wall mounted.

Other aspects, features and advantages of the present invention will be more fully apparent from the ensuing disclosure and appended claims.

### BRIEF DESCRIPTION OF THE DRAWINGS

FIG. 1 is a front elevation view of an FM transmitter and power supply/charging assembly according to one embodiment of the present invention.

FIG. 2 is a rear elevation view of the FM transmitter and power supply/charging assembly of FIG. 1.

FIG. 3 is a right-hand side view, in elevation, of the assembly of FIGS. 1-2.

FIG. 4 is a bottom plan view of the assembly of FIGS. 1-2.

FIG. 5 is a top plan view of the assembly of FIGS. 1-2.

FIG. 6 is a left-hand side view, in elevation, of the assembly of FIGS. 1-2.

FIG. 7 is a front elevation view of the FM transmitter and power supply/charging assembly of FIG. 1, with an MP3 player mounted therein.

FIG. 8 is a schematic representation of an audio system including the modular docking unit of the FM transmitter and power supply/charging assembly of the invention, having an MP3 player mounted therein, and arranged in FM transmitting relationship to an FM receiver having audio speakers attached thereto.

FIG. 9 is a pivotably adjustable ratchet adaptor, which is coupleable with a cigarette lighter power socket, e.g., a conventional 12 volt socket, wherein the outer coupling end of the adaptor is engagable with the port on the rear face of the docking unit of the FM transmitter and power supply/charging assembly, with the ratchet arm being pivotably adjustable to spatially position the MP3 player at a given orientation relative to a user.

FIG. 10 is a short adaptor coupleable with the coupling structure on the rear face of the docking unit of FIGS. 1-6, wherein the adaptor includes a wall mounting plate, accommodating wall mounting of the FM transmitter and power supply/charging assembly.

FIG. 11 is a desk mount device, in which the short adaptor of FIG. 10 may be reposed, to provide desktop access of a user to the MP3 player as reposed in the docking unit coupled with the adaptor mounted on the desk mount article.

FIG. 12 is a front elevation view of an FM transmitter and power supply/charging assembly, according to another embodiment of the present invention.

FIG. 13 is a left-hand side view, in elevation, of the assembly of FIG. 12.

FIG. 14 is a bottom plan view of the assembly shown in FIG. 12.

FIG. 15 is a rear elevation view of the FM transmitter and power supply/charging assembly of FIG. 12.

FIG. 16 is a right-hand side view, in elevation, of the assembly of FIG. 12.

FIG. 17 is a top plan view of the FM transmitter and power supply/charging assembly shown in FIG. 12.

FIG. 18 is a perspective view of an MP3 player having a connector adapted for coupling with a firewire port or a USB port.

FIG. 19 is a schematic front elevation view of an FM transmitter and power supply/charging assembly according to another embodiment of the invention, arranged for mounting therein of an MP3 player of the type shown in FIG. 18.

FIG. 20 is a schematic front elevation view of an adaptor for a personal digital assistant device, according to one embodiment of the invention.

FIG. 21 is a side elevation view showing the details of the left-hand side of the adaptor as illustrated in FIG. 20.

FIG. 22 is a front elevation view of the adaptor of FIG. 20, as matably engaged with a PDA device.

FIG. 23 is a schematic front elevation view of an adaptor for a personal digital assistant device, according to another embodiment of the invention.

FIG. 24 is a side elevation view showing the details of the right-hand side of the adaptor as illustrated in FIG. 23.

FIG. 25 is a front elevation view of the adaptor of FIG. 23, as matably engaged with a PDA device.

FIG. 26 is a schematic front perspective view of an adaptor for personal digital appliances, according to still another embodiment of the invention.

FIG. 27 is a back-side perspective view of the adaptor of FIG. 26.

### DETAILED DESCRIPTION OF THE INVENTION, AND PREFERRED EMBODIMENTS THEREOF

The present invention provides an integrated FM transmitter and power supply/charging assembly for an MP3 player, that dramatically increases the utility of the basic MP3 player.

The FM transmitter in the assembly of the invention transmits music played through the MP3 player to a range of FM frequencies, enabling FM reception of audio music signals that then can be played through an FM receiver, such as an FM radio receiver in a vehicle, a FM radio in proximity to the FM transmitter, and otherwise for extended area broadcast of the MP3 player-originated music.

As one example, the base dock unit of the FM transmitter and power supply/charging assembly may be deployed in an automobile or other vehicular environment, wherein the unit is powered by a power adaptor plugged into a cigarette lighter socket of the vehicle. The FM transmitter then transmits the MP3 player-originated music to the FM receiver in such vehicle, enabling the acoustic system of the vehicle to be employed for broadcast of the music to the interior passenger compartment of the vehicle.

The FM transmitter and power supply/charging assembly may as hereinafter described more fully comprise an AC charger enabling the battery of the MP3 player to be recharged to a more fully charged state allowing its use to be lengthened while on battery power.

The FM transmitter and power supply/charging assembly may be provided in a kit including the base docking unit and various adaptor/charger/mount accessories, as hereinafter described.

Although the ensuing discussion is directed to an embodiment having specific use and applicability to the iPOD MP3 player, it will be recognized that the utility of the invention is not thus limited, but rather extends to and encompasses other MP3 players. Accordingly, although the iPOD MP3 player utilizes a firewire port for power connection purposes, other types of port and electrical connection means may be employed.

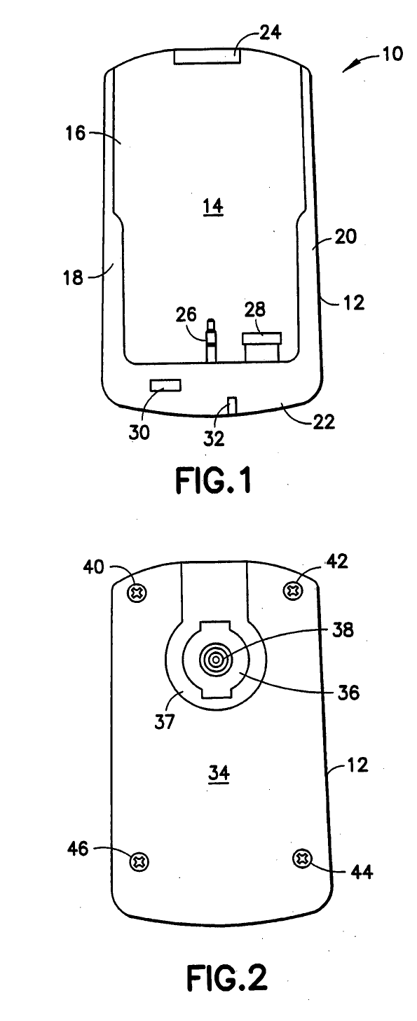

Referring now to the drawings, FIG. 1 shows a front elevation view of an FM transmitter and power supply/charging assembly 10 having a main body portion 12 including a back wall whose surface 14 together with side rails 18 and 20 define a cavity in which the MP3 player is selectively reposable. The FM transmitter and power supply/charging assembly will be referred to hereinafter as the modular docking unit.

As shown in FIG. 1, the modular docking unit is provided with a male connector element 26 matably engagable with the headphone port of the MP3 player, as well as a coupling 28 matably engagable with the firewire port of the MP3 player.

In the housing of the modular docking unit is provided an FM transmitter, which transmits music played through the MP3 player to a range of FM frequencies. The FM transmitter may be of any suitable type, and operates to transmit music to an FM receiver in the vicinity of the MP3 player.

The FM transmitter may for example be provided having a tuning frequency in the FM band of 88-95 megaherz (MHz) and a transmission range of 4-6 feet or more. Stereo transmitters of such type are readily commercially available, and are of appropriate size for incorporation in the modular docking unit.

The FM transmitter may simply transmit at a frequency fixed in the aforementioned 88-95 MHz band, or the transmitter may be tunable to select a specific frequency within such spectrum.

In operation, the FM receiver receives the transmitted audio from the MP3 player transmitted by the modular docking unit, and the FM receiver, e.g., in a user's automobile, then is able to transmit the audio content to the vehicular sound system, e.g., by tuning the FM receiver to the frequency of the transmitter in the modular docking unit.

The modular docking unit in the interior of its housing also includes circuitry and components for charging the battery of the MP3 player, through the firewire power port or other electrical input port (e.g., USB or other port) to charge the MP3 player's battery, as well as providing power to the MP3 player when docked in the modular docking unit.

As shown in FIG. 1, the modular docking unit has on a lower portion 22 thereof indicator lights 30 and 32, which are configured for indicating when the MP3 player is charging or fully charged, and/or when the MP3 player is “ON.”

The modular docking unit may also be provided with an ON/OFF switch, or selectively actuating the MP3 player, charging function of the modular docking unit, etc.

FIG. 2 is a rear elevation view of the MP3 player, showing the back wall surface 34, on which is provided a boss 37 forming a coupling cavity 36 including a power connector element 38. The housing of the modular docking unit may be of a 2-piece construction, with mechanical fastener elements 40, 42, 44 and 46 serving to couple the respective parts of the unit. Alternatively, the modular docking unit may be formed of a unitary molded material, having a port or opening therein for insertion and assembly of the interior components, including circuitry and components as described hereinabove.

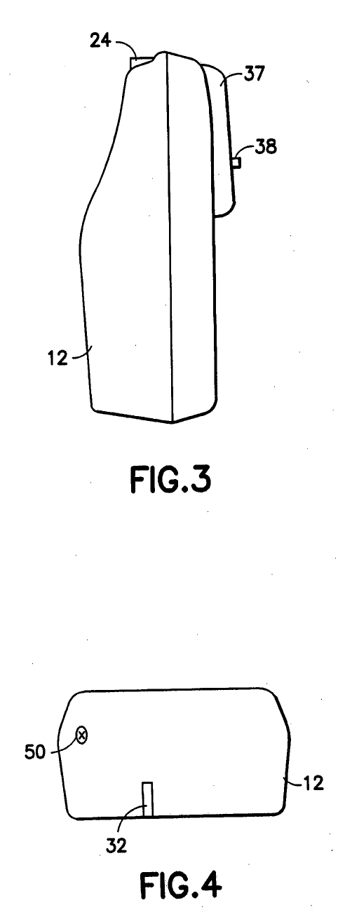

FIG. 3 is a right-hand side elevation view of the modular docking unit, showing the retention member 24 at the upper portion of the housing. FIG. 4 is a bottom plan view of the modular docking unit, including a further mechanical fastener 50 for retaining interior assembly elements of the unit.

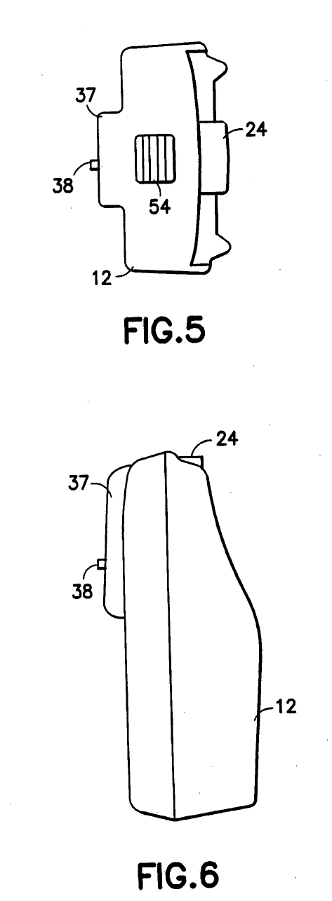

FIG. 5 is a top plan view of the modular docking unit, showing the retention member 24, which is selectively disengagable by thumb-actuatable release member 54.

FIG. 6 is a left-hand side elevation view of the modular docking unit, showing the symmetrical character of same relative to the view illustrated in FIG. 3.

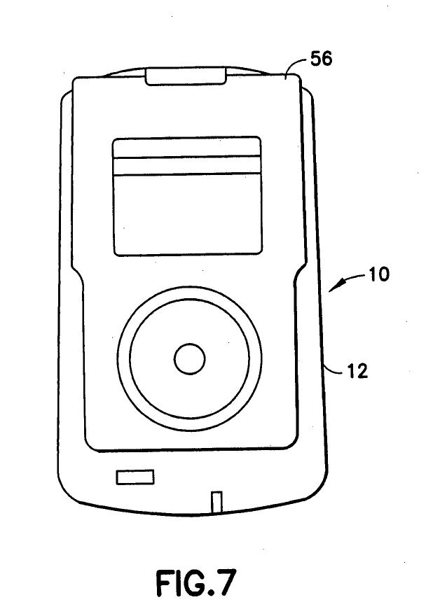

FIG. 7 illustrates the FM transmitter and power supply/charging assembly 10 having an MP3 player 56 disposed in the cavity of the body 12.

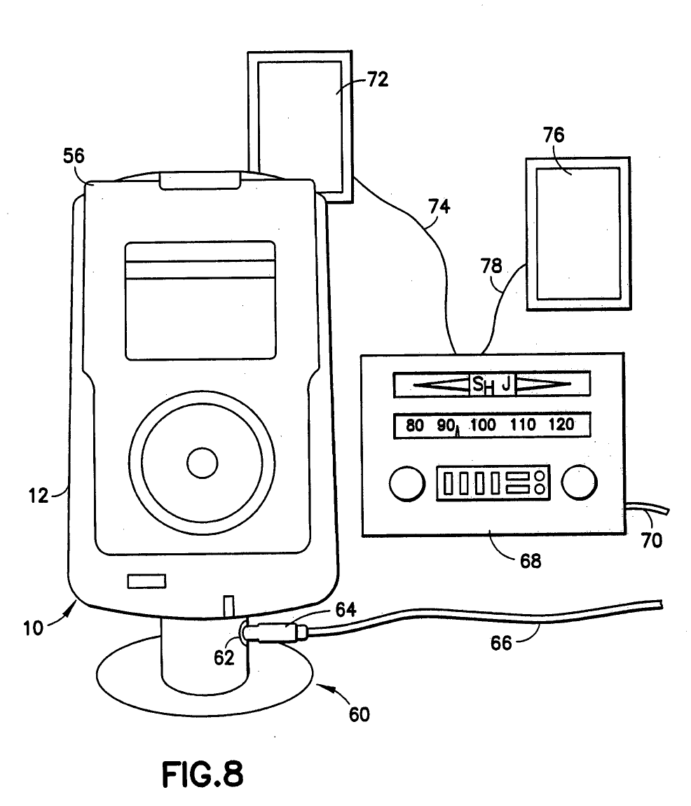

FIG. 8 is a corresponding view of MP3 player 56 mounted in the body 12 of the FM transmitter and power supply/charging assembly 10. In this configuration, the modular docking unit is mounted on a pedestal 60 having an arm extending upwardly at the rear of the modular docking unit and coupling with the power element 38 on boss 37 (see FIGS. 2, 3 and 6). The pedestal 60 is provided with an electrical coupling 62 accommodating power plug 64 connected to power cord 66, providing power to the pedestal 60 for transmittal through contact 38 to the MP3 player by element 28, as shown in FIG. 1.

When the MP3 player is actuated to play the stored audio content, the corresponding signal is transmitted through coupling element 26 shown in FIG. 1 to the FM transmitter in the housing of the modular docking unit, generating an FM signal that is transmitted to FM receiver 68 powered by power cord 70. The FM receiver 68 in turn is coupled by speaker wires 74 and 78 to speakers 72 and 76, respectively. In such manner, the audio content played by the MP3 player 56 is transmitted by the FM transmitter to FM receiver 68 and outputted as sound output at speakers 72 and 76.

Concurrently, the MP3 player can be electrically charged to renew the battery power of the unit, so that when undocked from the modular docking unit, the MP3 player may be outfitted with earphones and deployed in a personal listening arrangement.

Although the FIG. 8 embodiment is shown as including a table-type FM receiver, it will be recognized that the arrangement is illustrative only, and is adaptable to automotive or vehicular sound systems including an FM receiver.

The modular docking unit as shown in FIGS. 1-6 may be coupled with a power source in any suitable manner.

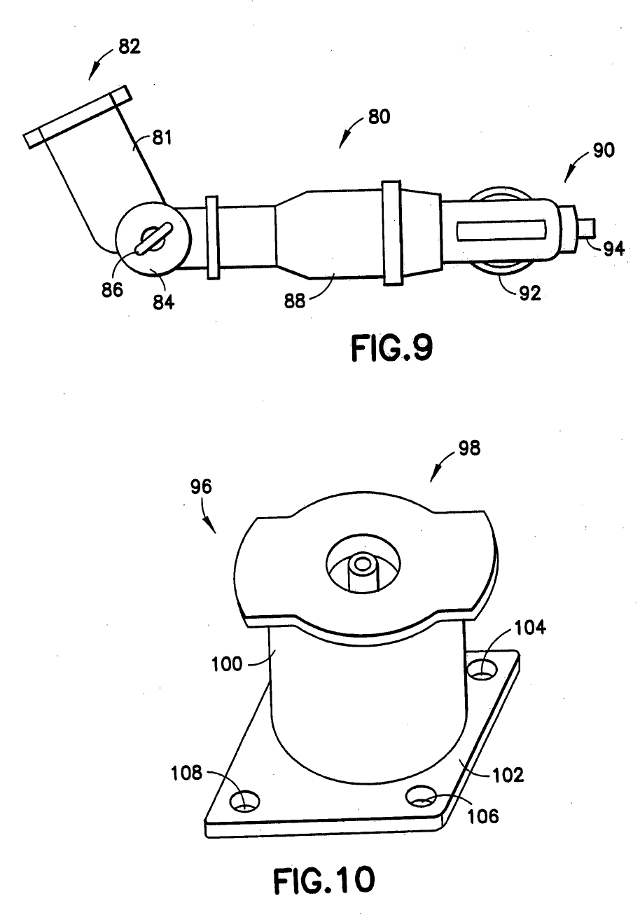

FIG. 9 shows a ratchet-type adaptor 80 including engagement structure 82 matable with the cavity 36 shown in FIG. 2 on the modular docking unit. The coupling structure 82 is at the face of tubular member 81 which is pivotably mounted on spindle 84 which is positionable by means of the manual wing-nut 86, which is selectively manually tightenable or loosenable, to adjust the attitude of tubular member 81 relative to the main body 88 of the adaptor. The main body 88 is joined to a plug end 90 featuring electrical contact elements 92 and 94, for engagement of the plug end 90 with a corresponding socket, such as a cigarette lighter socket of a motor vehicle.

FIG. 10 shows another adaptor 96 having engagement structure 98 at the extremity of cylindrical member 100 mounted on plate number 102. The engagement structure 98 is engagable with the cavity 37 at the rear face of the modular docking unit (see FIG. 2).

The plate 102 shown in FIG. 10 is provided with mounting openings 104, 106 and 108, for wall-attachment of the adaptor, using mounting screws, nails, etc.

The adaptor shown in FIG. 10 permits the modular docking unit to be wall-mounted, whereby the MP3 player may be selectively docked and undocked from the wall-mounted modular docking unit.

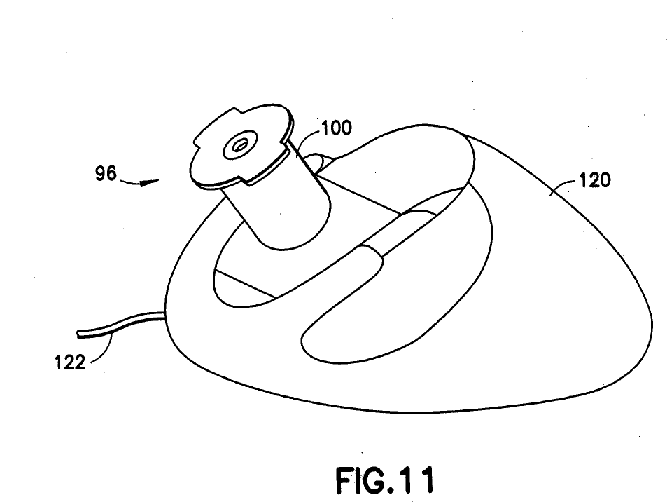

FIG. 11 is a perspective view of a desk mount article 120, in which the short adaptor 96 shown in FIG. 10 may be selectively reposed, or coupling with the desk mount article 120 joined to power cord 122.

The modular docking unit as shown in FIGS. 1-6 may thereby be coupled with the adaptor 96 of the desk mount article by engagement of the engagement structure with the cavity 37 and electrical coupling 38 as shown in FIG. 2.

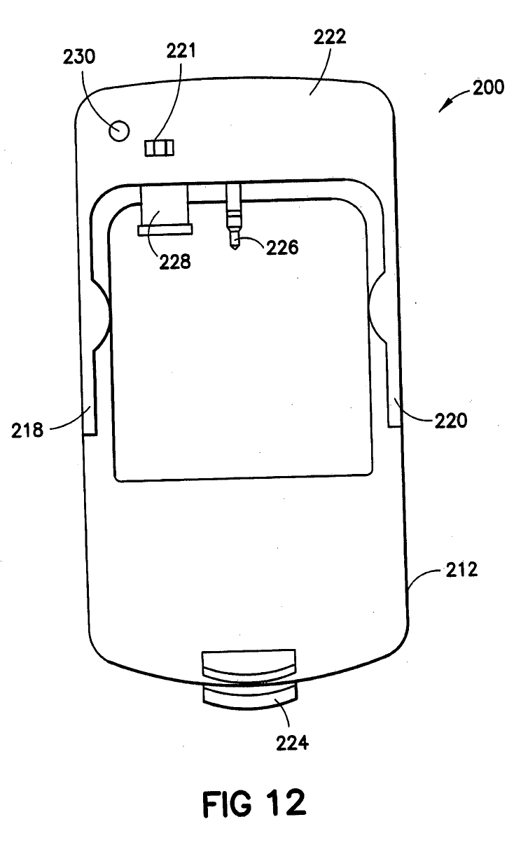

FIG. 12 is a front elevation view of an FM transmitter and power supply/charging assembly 200, or modular docking unit, according to another embodiment of the present invention.

The modular docking unit 200 includes a main body portion 212 defining a cavity for selectively reposing the MP3 player therein. The cavity is bounded by back wall 214 and side rails 218 and 220. Extending into the cavity is a male connector 226, which may serve to couple the modular docking unit with the headphone jack of the MP3 player, as well as a coupling 228 matably engagable with the firewire port of the MP3 player. The cavity as shown is also bounded by laterally inwardly facing elements, which serve as inwardly extending tabs on the respective side rails, to assist in retaining the MP3 player in position in the cavity during audio play, storage or charging of the player.

On the upper portion 222 of the modular docking unit 200 in the position shown, is provided an LED power indicator light 230, and a firewire port adjustment switch 221, which serves to laterally reposition the coupling 228 in the cavity, so that the coupling is placed in register with the firewire port of the MP3 player.

On the lower portion of the modular docking unit 200 in the position illustrated in FIG. 12, a retractable security shelf member 224 is provided. The shelf member 224 can be selectively manually adjusted to a forward position to assist in retaining the MP3 player in the cavity of the unit, so that the MP3 player is positionally fixtured in the cavity of the modular docking unit during use or charging of the MP3 player.

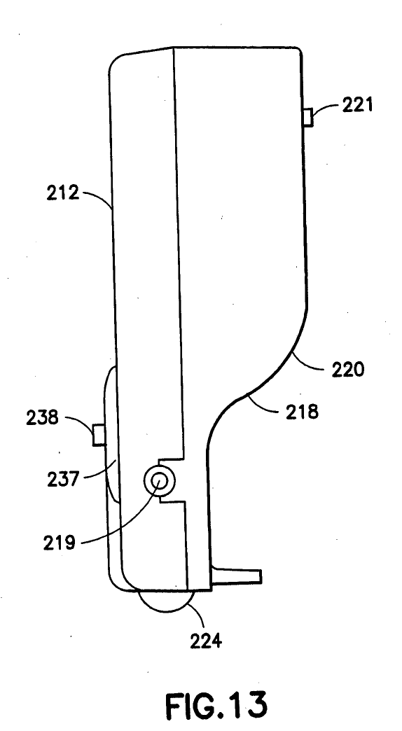

In the ensuing FIGS. 13-17, all parts and structural features of the modular docking unit are correspondingly numbered to the same parts and structural features as shown in FIG. 12, for ease of reference.

FIG. 13 is a left-hand side view, in elevation, of the modular docking unit 200 of FIG. 12, showing the boss 237 on the rear surface of the unit and the protruding power connector element 238. A headphone jack 219 is provided on the side surface of the unit, as shown, for selective use of the modular docking unit in a headphones-engaged listening mode when an MP3 player is mounted in the unit.

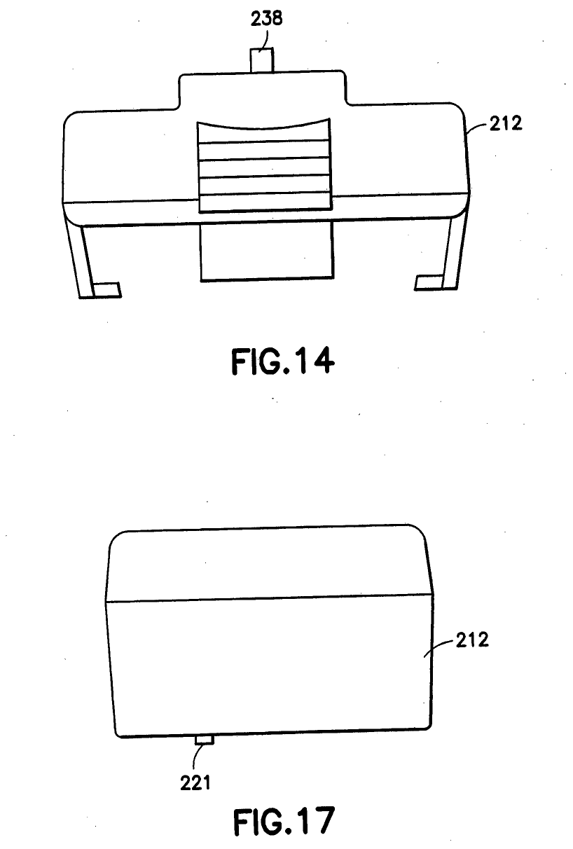

FIG. 14 is a bottom plan view of the modular docking unit shown in FIG. 12, showing the retractable security shelf 224. The shelf member includes a ridged surface to facilitate engagement with the thumb or other digit of the user, in selectively extending the shelf forwardly to secure the MP3 player in position, or alternatively to retract the shelf so that the MP3 player can be removed from the modular docking unit.

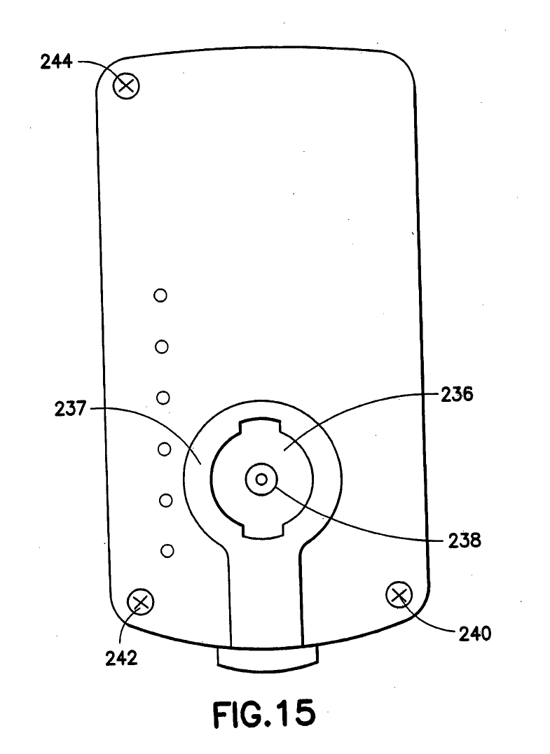

FIG. 15 is a rear elevation view of the modular docking unit of FIG. 12, showing the boss 237 on the back wall surface 234. The boss 237 forms a coupling cavity 236 including the power connector element 238 therein. The housing of the modular docking unit of this embodiment can be of two-piece construction, wherein each of the front and back sections of the housing are secured to one another by means of mechanical fasteners 240, 242 and 244, as shown. The housing of the modular docking unit may alternatively be formed of single-piece construction, or otherwise formed and fabricated in a suitable manner facilitating the assembly of the unit.

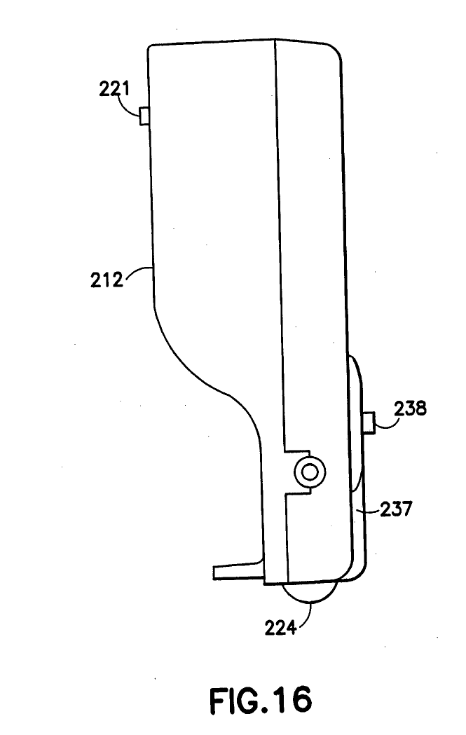

FIG. 16 is a right-hand side view, in elevation, of the assembly of FIG. 12, showing the boss 237 on the back wall surface and the power connector element 238 protruding therefrom. The retractable security shelf 224 is shown at the bottom of the unit in the view illustrated, and the firewire port adjustment switch 221 is shown protruding from the upper end of the unit.

FIG. 17 is a top plan view of the modular docking unit shown in FIG. 12, with the firewire port adjustment switch 221 protruding from the front surface of the main body portion 212 of the unit.

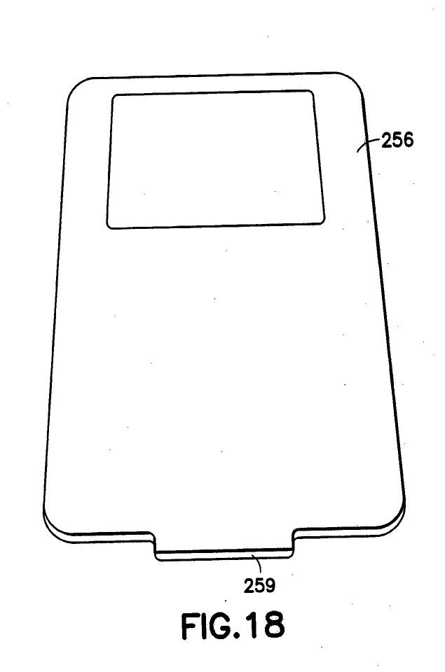

FIG. 18 is a perspective view of an MP3 player 256 having a connector 259 adapted for docking with a firewire port or a USB port. The MP3 player 256 illustrated in FIG. 18 is an iPOD™ MP3 player, available from Apple Computer, Inc., Cupertino, Calif., although other MP3 players can be used with the modular docking unit of the invention.

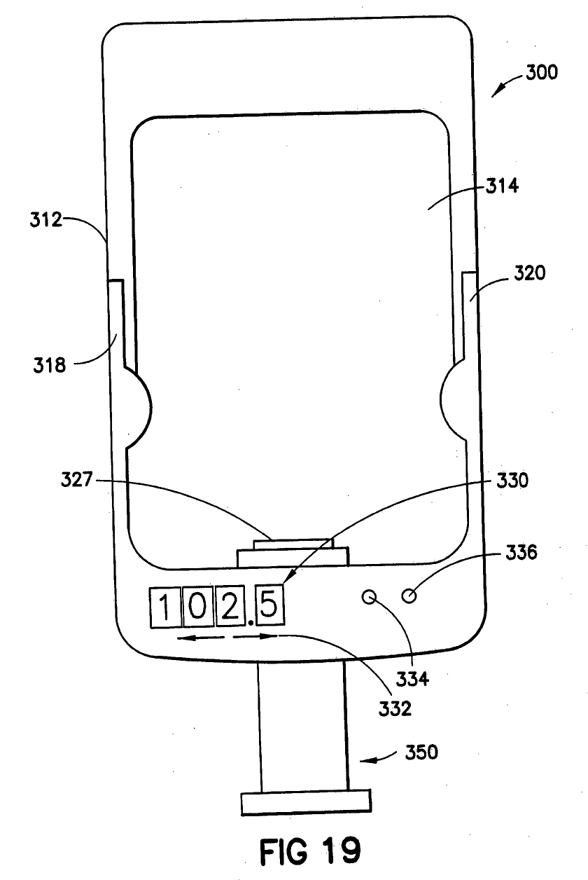

FIG. 19 is a schematic front elevation view of a modular docking unit 300 according to another embodiment of the invention, arranged for mounting therein of an MP3 player of the type shown in FIG. 18. The modular docking unit 300 includes a housing 312 defining a cavity therein bounded by back wall surface 314 and the side rails 318 and 320 of the housing. At the bottom extremity of the cavity is positioned a dock connector 327 that mates with the connector 259 of the MP3 player 256 (see FIG. 18).

The modular docking unit 300 has on a lower portion of the housing, on a frontal surface thereof, a frequency indicator display 330, which in the drawing indicates a frequency of 102.5 megahertz (MHz) being transmitted by the transmitter in the docking unit. Below the frequency indicator display is a tuning control 332, which can be variously configured as a membrane switch, as a thumb-wheel control, or other control member that is selectively actuatable to increase or decrease the transmitter frequency, as desired.

To the right of the frequency indicator display 330 on the lower portion of the housing 312 is a power indicator 334, which may comprise an LED or other suitable element indicating the power “ON” or “OFF” status of the unit. Adjacent to the power indicator 334 is an FM transmitter indicator element 336 which may likewise comprise an LED or other suitable element indicating the “ON” or “OFF” status of the FM transmitter disposed in the housing.

The modular docking unit 300 of FIG. 19 is shown as coupled to a flexible 12-volt cigarette lighter adapter 350, to enable the unit to be powered from the electrical system of a vehicle, by plug-in of the adapter 350 into the cigarette lighter of the vehicle. The connected modular docking unit 300 then is situated to receive the MP3 player in the cavity of the housing, and to be actuated to transmit audio from the MP3 player to the sound system of the vehicle in which the modular docking unit is mounted.

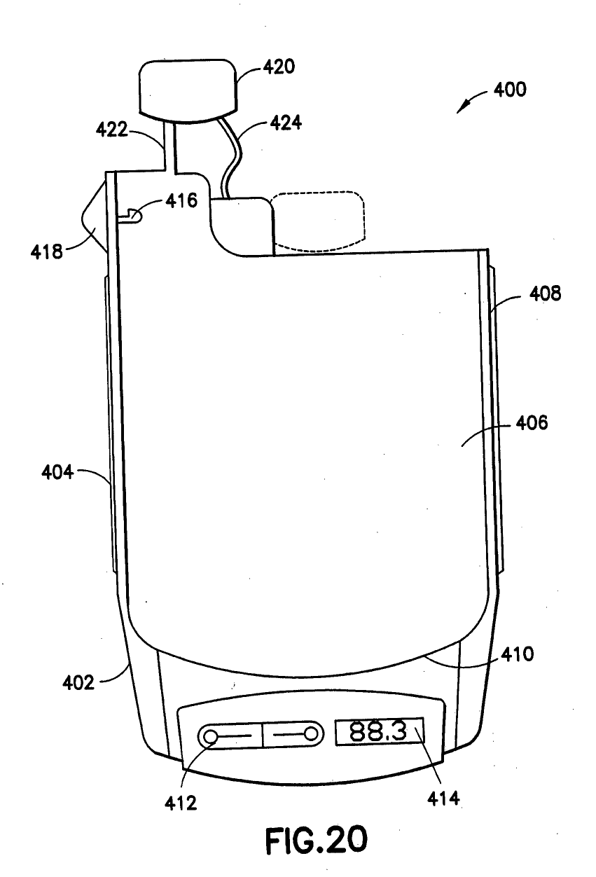

FIG. 20 is a schematic front elevation view of an adaptor 400 for a personal digital assistant device, according to one embodiment of the invention. The adaptor 400 has a main body portion 402 equipped with grips 404 and 406 on respective sides thereof, to facilitate manual grasping of the adaptor. The main body portion 402 contains the electronics and componentry for the various functions of the adaptor, and is shaped to form a recess 408 that is bounded by a recess edge 410. The recess edge contour is shaped to matably engage with a personal digital assistant of corresponding shape.

Projecting into the recess 408 is a projection element 416 for engagement with the PDA when docked in the adaptor, to lock the PDA in position in the recess. The projection element 416 is joined to slide button 418. The slide button is manually actuatable to release the PDA from the locked position when it is desired to uncouple the PDA from the adaptor.

At the upper portion of the adaptor is a signal jack 420 including a plug 422 and a connecting wire 424. The jack 420 is arranged to plug into a receiving opening (not shown) in the back of the adaptor, with the plug in the receiving opening, when the jack is not in use. When a PDA is docked with the adaptor 400, the signal jack is withdrawn from the receiving opening and plugged into a jack port in the PDA.

The adaptor is provided with a dock connector at the lower portion of the recess 408, similar to the dock connector 327 shown in the embodiment of FIG. 19, for coupling with the PDA. On the lower portion of the main body portion 402 of the adaptor is a control/display panel, including frequency-tuning switches 412 for increasing or decreasing the frequency of the FM signal transmitted by the adaptor. The frequency display 414 is beside the frequency-tuning switches 412 and provides a visual output showing the transmission frequency.

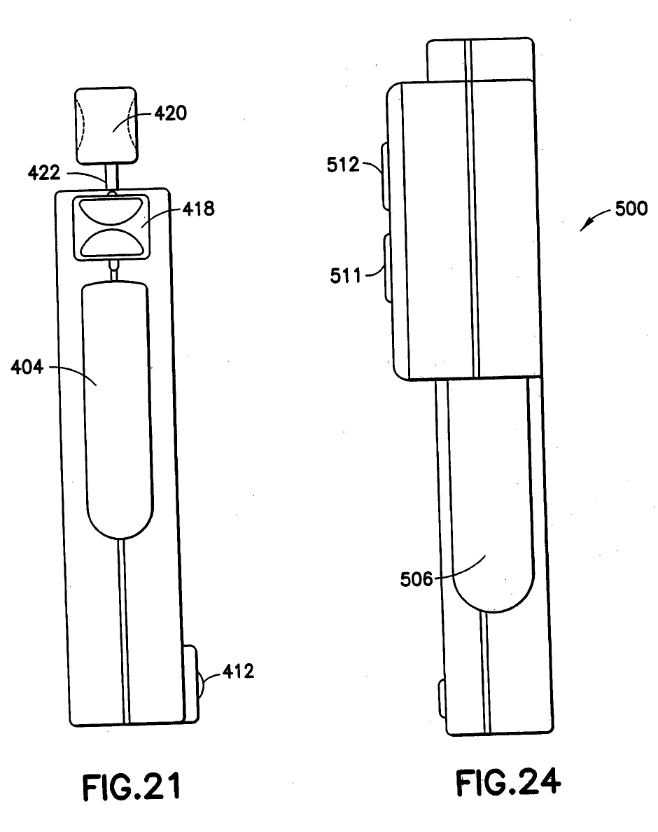

FIG. 21 is a side elevation view showing the details of the left-hand side of the adaptor as illustrated in FIG. 20, including the signal jack 420, and plug 422, slide button 418, side grip 404 and frequency-tuning switches 412.

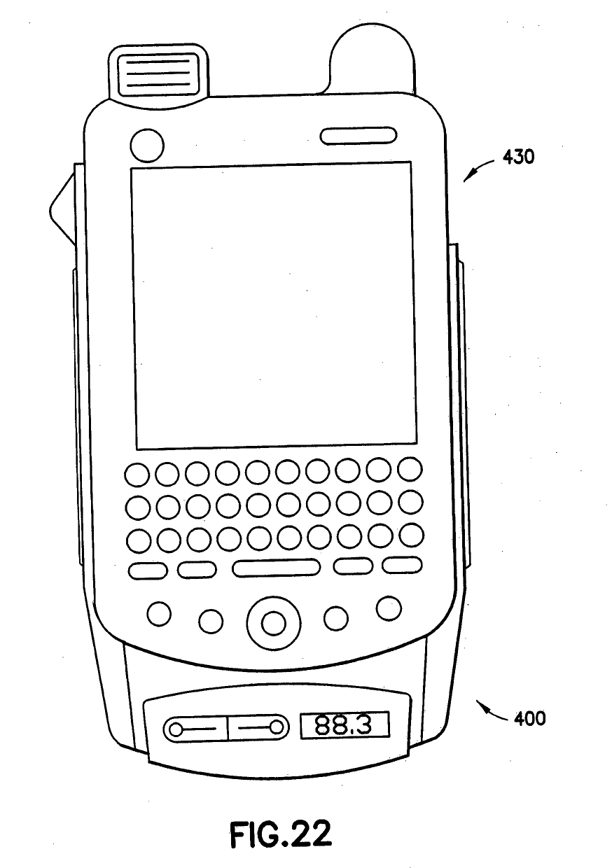

FIG. 22 is a front elevation view of the adaptor 400 of FIG. 20, as matably engaged with a PDA device 432, in which position the PDA when utilized as an MP3 player can transmit audio in the FM frequency spectrum in the manner previously described, or if the PDA is equipped with a voice interface, the audio output can likewise be transmitted in an FM frequency of interest.

If the PDA has wireless telephony capability, then the audio output from a caller can be transmitted in the FM frequency spectrum to an available FM receiver, such as in an automotive sound system, in a vehicle in which the adaptor/PDA is being deployed. By transmitting such telephony output to the automotive sound system, the driver is freed from the necessity of holding the PDA telephone, since the adaptor is able to be plugged into a 12 volt cigarette lighter of the vehicle, in the previously described manner, when configured with an appropriate coupling for such purpose, as previously described. In addition to enhancing the safety of wireless telephony operation, such arrangement also has the advantage that the audio from the other party in the telephone conversation can be heard over the sound system of the automobile, which is typically of much higher quality than wireless telephony speakers. This enhances the telephonic experience, by avoiding having the wireless phone compete with road noise of the vehicle, such as would be the case in the event that the wireless telephone were held to the ear of the driver. The driver thereby can operate the vehicle with both hands devoted to such task, with consequent safety and other advantages.

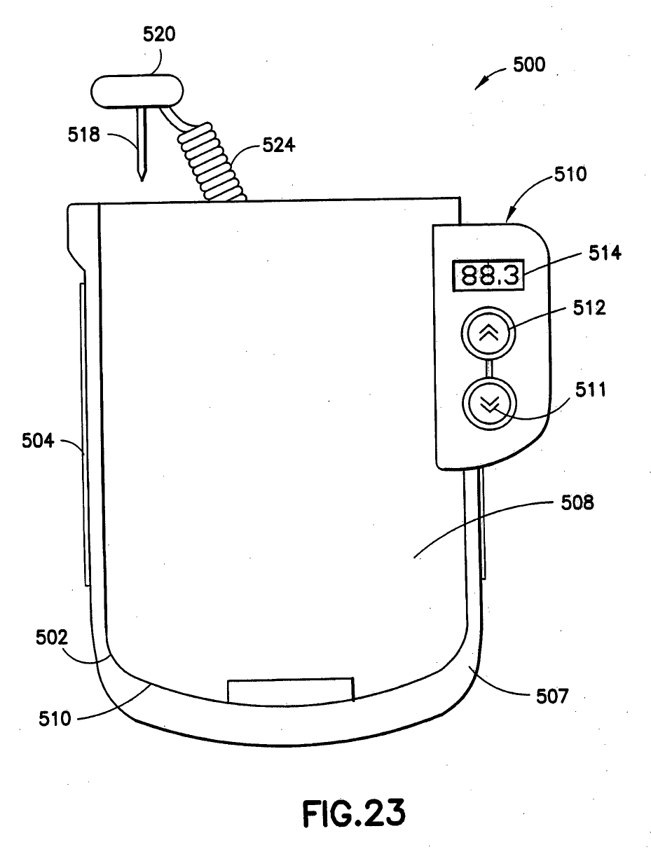

FIG. 23 is a schematic front elevation view of an adaptor 500 for a personal digital assistant device, according to another embodiment of the invention. The adaptor 500 has a main body portion 502 equipped with grips 504 and 506 (see FIG. 24) on respective sides thereof, to facilitate manual grasping of the adaptor. The main body portion 502 contains the electronics and componentry for the various functions of the adaptor, and is shaped to form a recess 508 that is bounded by a recess edge 510 at the sides and at the lower portion 507 of the adaptor. The recess edge contour is shaped to matably engage with a personal digital assistant of corresponding shape.

Projecting into the recess 508 is a spring-loaded ball bearing element 516 for engagement with the PDA when docked in the adaptor, to lock the PDA in position in the recess, with the ball bearing element reposed in a cavity in the side panel of the PDA. The spring-loaded ball bearing element functions to retain the PDA in position, but is readily compressed against the associated spring element to release the PDA from the locked position when it is desired to uncouple the PDA from the adaptor, by exertion of gentle manual pressure on the PDA to extract it from the adaptor.

At the upper portion of the adaptor is a signal jack 520 including a plug 518 and a connecting wire 524. The jack 520 is arranged to plug into a receiving opening (not shown) in the back of the adaptor, with the plug in the receiving opening, when the jack is not in use. When a PDA is docked with the adaptor 500, the signal jack is withdrawn from the receiving opening and plugged into a jack port in the PDA.

The adaptor is provided with a dock connector at the lower portion of the recess 508, similar to the dock connector 327 shown in the embodiment of FIG. 19, for coupling with the PDA. At the upper right-hand part of the main body portion 502 of the adaptor is a control/display panel, including frequency-tuning switches 511 and 512 for increasing or decreasing the frequency of the FM signal transmitted by the adaptor, and the frequency display providing a visual output showing the FM transmission frequency.

FIG. 24 is a side elevation view showing the details of the right-hand side of the adaptor 500 as illustrated in FIG. 23, including the frequency-tuning switches 511 and 512, and the side grip 506.

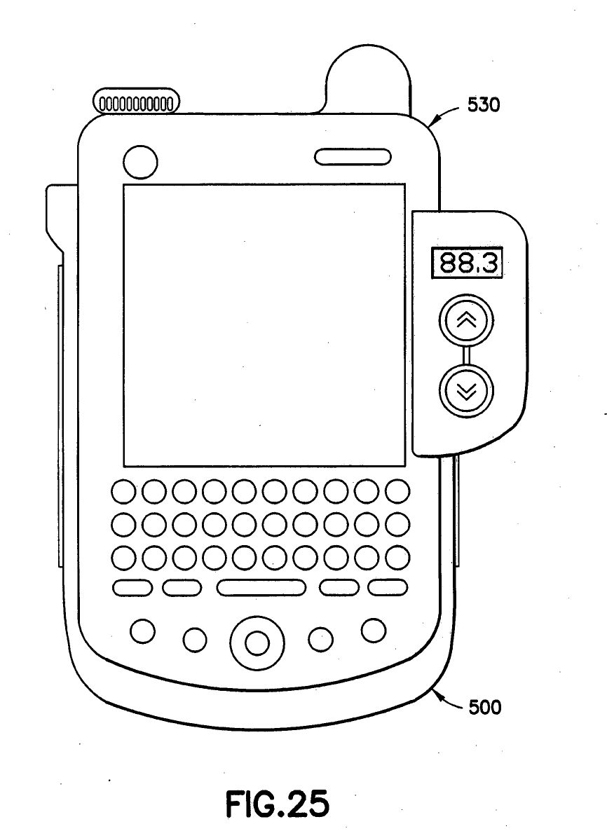

FIG. 25 is a front elevation view of the adaptor of FIG. 23, as matably engaged with a PDA device 530. As illustrated, the control/display panel in this embodiment serves as a retention structure for a PDA when docked in the adaptor.

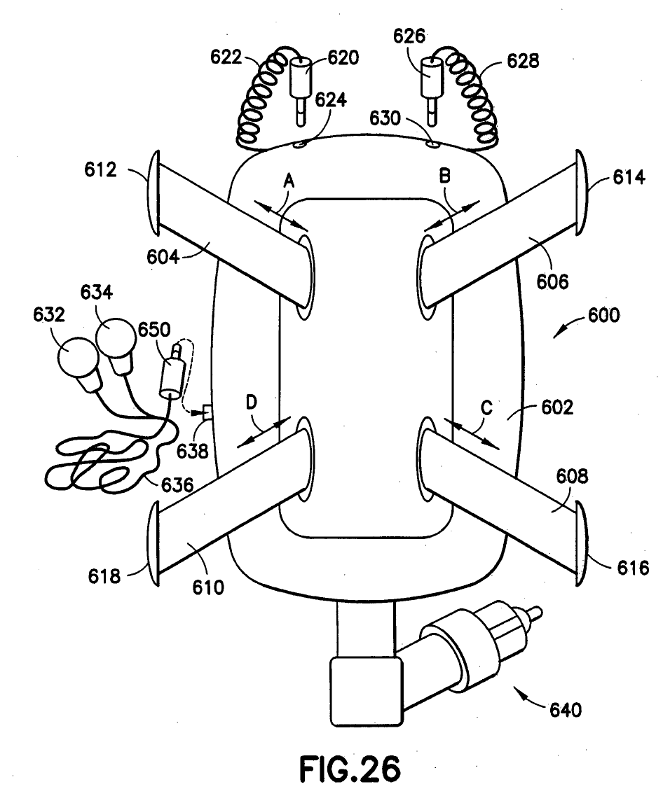

FIG. 26 is a schematic front perspective view of an adaptor 600 for personal digital appliances, according to still another embodiment of the invention. The adaptor 600 in this embodiment has a main body portion 602. Extending laterally outwardly from the main body portion 602 are four spring-loaded retention arms with side grip members at their respective extremeties, including retention arm 604 with grip member 612, retention arm 606 with grip member 614, retention arm 608 with grip member 616 and retention arm 610 with grip member 618. The four retention arms 604, 606, 608 and 610 are slidable laterally in the slots in the main body portion, in the directions indicated by arrows A, B, C and D, respectively, being spring-biased, so as to exert compressive action against the side panels of a personal digital appliance when the arms are extended and a personal digital appliance is positioned in retained position, with the grip members bearing against the respective sides thereof.

It will be recognized that the retention arm arrangement shown in FIG. 26 is illustrative in character and that numerous other means and approaches can be employed to matably engage the personal digital appliance with the adaptor.

The adaptor 600 is provided with an audio jack 620 at the upper portion of the main body portion, with the audio jack being coupled by cord 622 to the interiorly disposed electronics of the adaptor. The audio jack when the adaptor is not engaged with a personal digital appliance is reposed in opening 624 of the main body portion, as a “storage” position for such audio jack. The audio jack is plugged into the personal digital appliance when the appliance is docked with the adaptor.

In like manner, the adaptor 600 includes an AC/power jack 626 on cord 628, which is plugged into the personal digital appliance when the appliance is engaged with the adaptor in use. When not in such use, the AC/power jack 626 is plugged into opening 630 in the main body portion of the adaptor, in the corresponding storage position.

The adaptor 600 at its left-hand side panel, in the view shown, is equipped with a microphone/earphone port 638, into which the earphones 632 and 634 on cord 636 may be plugged by means of plug 650.

The adaptor 600 is shown as being coupled to a power connector 640, which may be plugged into a 12-volt cigarette lighter of a vehicle, in the previously described manner. Alternatively, the power connector 640 may be changed out or substituted by a wall mount, desk mount or other connector assembly, by means of which the adaptor can be interconnected with a source of power for recharging the battery of the personal digital appliance, or otherwise for powering the personal digital appliance in use, in the docked position.

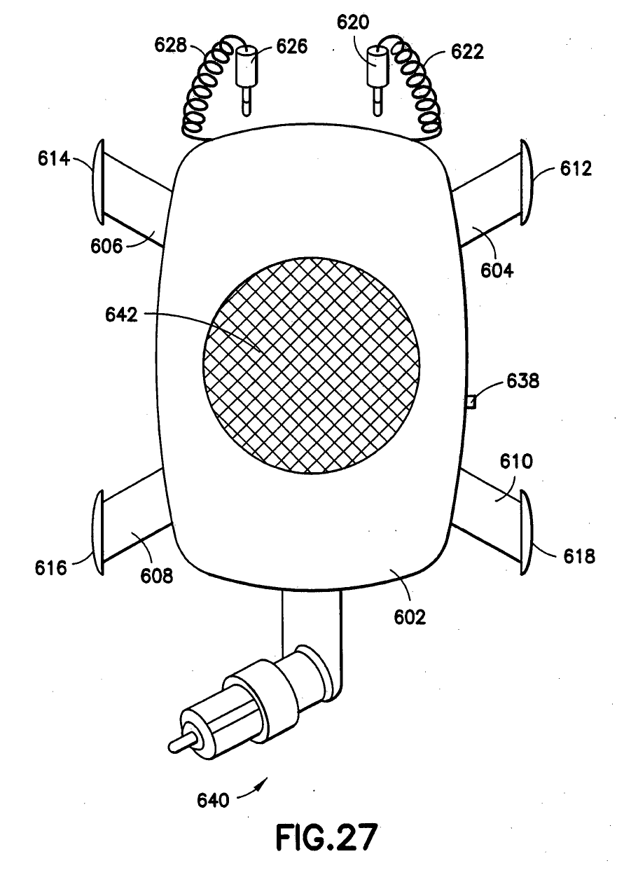

FIG. 27 is a back-side perspective view of the adaptor of FIG. 26, showing the elements and features thereof. The adaptor 600 as shown in FIG. 27 has a dedicated speaker 642 for providing audio output, as may be required with some personal digital appliances whose wireless telephony components may not work with an FM transmitter. The adaptor may be used with a microphone in place of the earphones illustratively shown in FIG. 26, or alternatively the adaptor can be fabricated with a built-in microphone as an input means for voice input for cell phone use or for use with any voice recognition functionality that may be incorporated in the operating system of the personal digital appliance.

It will therefore be recognized that the adaptor and its FM transmitter, power supply/charging components, and other componentry may be widely varied in specific structure, while providing FM transmission ability to the MP3 player, cellular telephone, personal digital assistant, or other personal digital appliance docked therein, and concurrently providing charging capability to the personal digital appliance, as well as power during docked usage of the personal digital appliance.

The various adaptor units shown, as well as the associated mounting articles, may be provided as a kit together with the FM transmitter and power supply/charging assembly, to provide a package of alternative parts for varied deployment of the docked personal digital appliance.

While the invention has been described herein with respect to various illustrative aspects, features and embodiments, it will be recognized that the invention is not thus limited, but that the present invention extends to and encompasses other features, modifications, and alternative embodiments, as will readily suggest themselves to those of ordinary skill in the art based on the disclosure and illustrative teachings herein. The claims that follow are therefore to be construed and interpreted as including all such features, modifications and alternative embodiments, within their spirit and scope.

1. An adaptor for a personal digital appliance, said adaptor including an FM transmitter and power supply/charging assembly electrically coupleable with the personal digital appliance, the adaptor comprising a modular docking unit having a main body portion with a docking cavity therein, wherein the main body portion contains said FM transmitter and power/charging circuitry, with coupling means in the docking cavity for connecting the personal digital appliance with the FM transmitter and power/charging circuitry, to accommodate FM transmission by said FM transmitter of audio content when produced by said personal digital appliance in the docking cavity of the modular docking unit, and with means for transmitting electrical power through said modular docking unit and said power/charging circuitry therein, for charging of a battery of the personal digital appliance and/or powering of the personal digital appliance.

2. The adaptor of claim 1, further comprising retention means for retaining the personal digital appliance in position in the cavity.

3. The adaptor of claim 1, wherein the coupling means in the docking cavity comprises a firewire coupling.

4. The adaptor of claim 1, wherein the coupling means in the docking cavity comprises a USB port.

5. The adaptor of claim 1, wherein the modular docking unit comprises at least one indicator light indicative of the operational state of the unit.

6. The adaptor of claim 5, wherein the indicator light indicates the “ON” or “OFF” state of the unit.

7. The adaptor of claim 5, wherein the indicator light indicates the charging status of a battery in a personal digital appliance docked in the cavity of the modular docking unit.

8. The adaptor of claim 1, wherein the modular docking unit comprises a housing formed of polymeric material.

9. The adaptor of claim 1, wherein the FM transmitter has a transmission range of up to about 6 feet.

10. The adaptor of claim 1, wherein the FM transmitter produces an output frequency audio signal in a range of from about 85 to about 95 Megaherz.

11. The adaptor of claim 10, wherein said FM transmitter produces a single output frequency signal in said range.

12. The adaptor of claim 10, wherein said FM transmitter produces a variable output frequency signal in said range.

13. The adaptor of claim 1, which is constructed and arranged to dock with an iPOD™ MP3 player.

14. The adaptor of claim 1, which is constructed and arranged to dock with a personal digital assistant.

15. The adaptor of claim 1, which is constructed and arranged to dock with an MP3 player.

16. The adaptor of claim 1, which is constructed and arranged to dock with a wireless telephone.

17. The adaptor of claim 1, which is constructed and arranged to dock with a integrated personal digital assistant having wireless telephony functionality.

18. The adaptor of claim 1, which is constructed and arranged to dock with an integrated personal digital assistant having telephony, MP3, computational and wireless network access functionality.

19. The adaptor of claim 1, comprising a frequency indicator on the main body portion.

20. The adaptor of claim 1, comprising a frequency tuning control on the main body portion.

21. The adaptor of claim 1, wherein the main body portion has a generally rectangular shape.

22. The adaptor of claim 1, further comprising a headphones jack on the main body portion and coupled to said circuitry.

23. A system including an adaptor as in claim 1, and a personal digital appliance docked in the docking cavity of the modular docking unit of said adaptor.

24. The system of claim 23, arranged for transmission of music to a table-type FM receiver.

25. The system of claim 23, arranged for transmission of audio output to a vehicular FM receiver for outputting of sound from vehicular audio speakers.

26. The system of claim 23, wherein the FM transmitter has a transmission range of up to about 6 feet.

27. The system of claim 23, wherein the FM transmitter produces an output frequency audio signal in a range of from about 85 to about 95 Megaherz.

28. The system of claim 23, wherein the FM transmitter produces an output variable frequency audio signal in a range of from about 85 to about 95 Megaherz.

29. A digital appliance accessory kit, comprising an adaptor as in claim 1, and at least one power connector/charger element for use therewith.

30. An FM transmitter and power supply/charging assembly electrically coupleable with an MP3 player, said assembly comprising:
a main body portion containing FM transmitter and power/charging circuitry;
coupling means for connecting the MP3 player with the FM transmitter and power/charging circuitry, to accommodate FM transmission by said FM transmitter of audio content when played by said MP3 player; and
means for transmitting electrical power through said power/charging circuitry and said coupling means, for charging of a battery of the MP3 player and/or powering of the MP3 player.

31. The assembly of claim 30, wherein the FM transmitter produces an output frequency audio signal in a range of from about 85 to about 95 Megaherz.

32. The assembly of claim 30, wherein the FM transmitter produces a single output frequency signal in said range.

33. The assembly of claim 30, wherein the FM transmitter produces a variable output frequency signal in said range.

34. The assembly of claim 30, wherein the means for transmitting electrical power through said power/charging circuitry and said coupling means, comprises a plug connector engageable with a cigarette lighter socket of a motor vehicle.

35. An FM transmitter and power supply/charging assembly electrically coupleable with an MP3 player, said assembly comprising an FM transmitter and power/charging circuitry, and a docking unit with a docking cavity therein for receiving an MP3 player, wherein the docking unit is constructed and arranged for connecting the MP3 player with said FM transmitter and power/charging circuitry, to accommodate FM transmission by said FM transmitter of audio content when played by said MP3 player in the docking cavity of the docking unit, and with means for transmitting electrical power through said power/charging circuitry, for charging of a battery of the MP3 player and/or powering of the MP3 player.

36. An FM transmitter and power supply/charging assembly electrically coupleable with an MP3 player, said assembly comprising:
a docking unit with a docking cavity therein for receipt of an MP3 player;
an FM transmitter connectable with said MP3 player for FM transmission of audio content played by said MP3 player; and
power/charging circuitry connectable with said MP3 player for transmission of electrical power therethrough to charge and/or power the MP3 player.

37. An FM transmitter and power supply/charging assembly electrically coupleable with an MP3 player, said assembly comprising:
an FM transmitter connectable with said MP3 player for FM transmission of audio content played by said MP3 player; and
power/charging circuitry connectable with said MP3 player for transmission of electrical power therethrough to charge and/or power the MP3 player.

38. A docking and power supply/charging assembly electrically coupleable with an MP3 player, said assembly comprising:
structure defining a docking cavity for receipt therein of an MP3 player; and
power/charging circuitry connectable with said MP3 player for transmission of electrical power therethrough to charge and/or power the MP3 player.

39. An audio transmitter and power supply/charging assembly electrically coupleable with an MP3 player, said assembly comprising:
an audio transmitter connectable with said MP3 player for transmitting audio content played by said MP3 player to a separate audio player that is independent of said MP3 player; and
power/charging circuitry connectable with said MP3 player for transmission of electrical power therethrough to charge and/or power the MP3 player.
